(19) United States
(12) Patent Application Publication
(10) Pub. No.: US 2022/0207992 A1
(43) Pub. Date: Jun. 30, 2022

(54) SURPRISE PEDESTRIAN DENSITY AND FLOW

(71) Applicant: HERE Global B.V., Eindhoven (NL)

(72) Inventor: James Adeyemi Fowe, Chicago, IL (US)

(21) Appl. No.: 17/537,133

(22) Filed: Nov. 29, 2021

Related U.S. Application Data
(60) Provisional application No. 63/132,116, filed on Dec. 30, 2020.

(51) Int. Cl. G08G 1/01; G08G 1/052; G06F 16/29

(52) U.S. Cl. CPC G08G 1/0129; G08G 1/0133; G06F 16/29; G08G 1/012; G08G 1/052; G08G 1/0145

(57) ABSTRACT

System and methods are provided to detect, capture, and report pedestrian density and flow for an intelligent traffic system. A mapping system periodically obtains and calculates a historical pedestrian density pattern (PDP) and a historical pedestrian flow pattern (PFP) over a period of time. The mapping system acquires and calculates a real time PDP and a real time PFP. Surprise pedestrian density and flow values are calculated by finding a difference between current (real-time) metrics with the historical metrics.

### CROSS REFERENCE TO RELATED APPLICATIONS

This application claims the benefit of the filing date under 35 U.S.C. § 119(e) of Provisional U.S. Patent Application Ser. No. 63/132,116, filed on Dec. 30, 2020, which is hereby incorporated by reference in its entirety.

### FIELD

The following disclosure relates to navigation devices or services.

### BACKGROUND

Smart cities and intelligent traffic systems need to optimize transport options for residents, city workers, and tourists. Pedestrian mobility is increasingly being encouraged as an important means of travel within compact central city areas for health and environmental reasons. Intelligent traffic systems need to be resilient and reactive to changing patterns in pedestrian mobility. There is a need for government officials, public health officials, and other affected entities to get analytical insight on pedestrian location density and flow (OD movement, etc.).

Past attempts to track pedestrian density and flow have relied upon physical sensors such as cameras, weight sensors, and IR sensors that are installed in and around a city center. In one example, pedestrian sensors were installed inconspicuously on awnings or street poles above the ground and operated using two beams of infra-red laser light that scanned the area below to count the number of pedestrians passing. In another example, pedestrians have been tracked by traffic camera or security cameras. Both of these methods are difficult and expensive to implement as these methods include installing and maintaining physical hardware. These methods also have limited reach and may only be able to cover certain areas. In addition, cameras and image recognition may be seen as an invasion of privacy for some pedestrians. There is a need for improved methods of collection, filtering, and analysis of pedestrian mobility data that does not require installation of physical devices.

### SUMMARY

In an embodiment, a method is provided for tracking pedestrian mobility. The method includes acquiring pedestrian probe data from a plurality of probe apparatuses traversing a roadway network; map matching each of the pedestrian probe data to respective links; calculating a real time pedestrian density pattern metric based on the map matched pedestrian probe data for a current time period; calculating a real time pedestrian flow pattern metric based on pedestrian count and average flow speed derived by matching sequences of pedestrian probe data for respective links to origination and destination areas and obtaining average travel time aggregated over the current time period; and determining a surprise pedestrian density value and a surprise pedestrian flow value by calculating a difference between a historical pedestrian flow pattern metric and a historical pedestrian density pattern metric stored in a geographic database and the real time metrics

In an embodiment, a system is provided for tracking pedestrian mobility. The system includes a geographic database and a mapping server. The geographic database is configured to store pedestrian probe data acquired from a plurality of probe apparatuses traversing a roadway network. The mapping server is configured to map match each of the pedestrian probe data to respective links, calculate a real time pedestrian density pattern metric based on the map matched pedestrian probe data for a current time period, and calculate a real time pedestrian flow pattern metric based on pedestrian count and average flow speed derived by matching sequences of pedestrian probe data for respective links to origination and destination areas and obtaining average travel time aggregated over the current time period. The mapping server is further configured to determine a surprise pedestrian density value and a surprise pedestrian flow value by calculating a difference between a historical pedestrian flow pattern metric and a historical pedestrian density pattern metric stored in a geographic database and the real time metrics.

In an embodiment, an apparatus is provided including at least one processor; and at least one memory including computer program code for one or more programs; the at least one memory configured to store the computer program code configured to, with the at least one processor, cause the at least one processor to: acquire pedestrian probe data from a plurality of probe apparatuses traversing a roadway network; map match each of the pedestrian probe data to respective links; calculate a real time pedestrian density pattern metric based on the map matched pedestrian probe data for a current time period; calculate a real time pedestrian flow pattern metric based on pedestrian count and average flow speed derived by matching sequences of pedestrian probe data for respective links to origination and destination areas and obtaining average travel time aggregated over the current time period; and determine a surprise pedestrian density value and a surprise pedestrian flow value by calculating a difference between a historical pedestrian flow pattern metric and a historical pedestrian density pattern metric stored in a geographic database and the real time metrics.

### BRIEF DESCRIPTION OF THE DRAWINGS

Exemplary embodiments of the present invention are described herein with reference to the following drawings.

FIG. 1 depicts an example system for tracking pedestrian mobility according to an embodiment.

FIG. 2 depicts an example region of a geographic database.

FIG. 3 depicts an example geographic database of FIG. 1.

FIG. 4 depicts an example structure of the geographic database.

FIG. 5 depicts an example workflow tracking pedestrian mobility according to an embodiment.

FIG. 6 depicts an example of different probe data types.

FIG. 7 depicts an example of probe data overlaid on a geographic map.

FIG. 8 depicts an example of an origin destination matrix according to an embodiment.

FIG. 9 depicts an example device of FIG. 1 according to an embodiment.

### DETAILED DESCRIPTION

Embodiments described herein provide systems and methods to detect, capture and report pedestrian density and flow for an intelligent traffic system. A mapping system periodically obtains and calculates a historical pedestrian density pattern (PDP) and a historical pedestrian flow pattern (PFP) over a period of time, for example weekly, monthly, quarterly, and/or yearly. One component in the pedestrian density pattern is a count of pedestrians over a geographic area (quadkey or zip code) or a point of interest (POI). Components in the pedestrian flow pattern include both the count and average flow speed (or travel-time) over a linear or an origin destination (OD) pair. The pedestrian density pattern is generated using probe data analytics and algorithms in which probes are map-matched to areas and linear (with varying granularity) and aggregated using day-epoch or week-epochs over a period of time. The metrics in the pedestrian flow pattern are generated using probe data analytics and algorithms in which probes are map-matched to OD areas (with varying granularity) and obtaining average travel time or journey times in OD and aggregated using day-epoch or week-epochs over a period of time. Surprise pedestrian density and flow metrics are calculated by finding a difference between current (real-time) metrics with the historical metrics.

It is increasingly important and yet challenging to track pedestrian mobility because of the accuracy of GPS and navigation systems that are primarily designed for vehicles. With the recent pandemic that recommends physical distancing, there is a need for government and public health officials to get analytical insight on pedestrian location density and flow (OD movement, etc.). Another problem is that retail companies are struggling to understanding new and changing pedestrian mobility patterns (PMP). Embodiments provide an ability to capture the emerging changes that may help these businesses make informed decisions.

For most cities, the busiest days of the week as well as the busiest hours for pedestrian traffic are typically from 7 am-9 am, 12 pm-1 pm, and 4 pm-6 pm consistently occurring throughout the week, reflecting the starting, lunch, and ending periods typical of businesses. Insights that may be drawn from this analysis include looking into the availability of public transportation, for example, by adjusting inbound and outbound city services to better match peak times (7 am-9 am) and non-peak times (10 am-11 am). Understanding the movement patterns of pedestrians as well as the density of pedestrians may also aid in infrastructure maintenance. While, this simple model may be generalized over the entirety of a city, it fails to capture the actual movement of pedestrians between different locations and points of interest. The generalized pedestrian traffic patterns are not reflective of actual pedestrian movements that may vary significantly due to the many distinct events that may occur in a city such as street or sidewalk closures, protests, store openings, late trains or transit, accidents, etc. Existing pedestrian traffic data is thus not indicative of the actual pedestrian mobility and may not be helpful in making real time decisions. Embodiments described herein provide a real time assessment that is allows for dynamic decision making. Transportation systems may be updated in real time to account for unexpected density or traffic volume. Decisions to shut down or open up streets may be made in real time based on the real time assessments. In addition, businesses may provide more nimble services.

In order to provide real time pedestrian movements analysis, embodiments use probe analytics of pedestrian density and flow patterns with HD maps to obtain changes or surprises, sudden surges, or reductions in pedestrian mobility in various locations. Pedestrian probe data (for example GPS data) is obtained and processed in various forms (for example probe points, probe trajectories, probe paths, origin-destination, OD trajectories, micro-ODs). A pedestrian density pattern (PDP) metric based on pedestrian count is then generated by map matching probe data to areas/roads/lanes and aggregating the probe data over a period of time (for example using day/week epochs). A pedestrian flow pattern (PFP) metric based on pedestrian count and average flow speed (or travel time) is generated by map-matching probes to OD areas and roads/lanes and then obtaining average travel time aggregated over a period of time (for example using day/week epochs). Then a surprise pedestrian density and flow values are obtained by calculating a difference between real time metrics and historical metrics.

The following embodiments relate to several technological fields including but not limited to navigation, traffic applications, and other location-based systems. The following embodiments achieve advantages in each of these technologies because an increase in the accuracy of the identification of dangerous conditions improves the effectiveness, efficiency, and speed of specific application in these technologies. In each of the technologies of navigation, traffic applications, and other location-based systems, improved identification of pedestrian movement improves the technical performance of the application. In addition, users of navigation, traffic applications, and other location-based systems are more willing to adopt these systems given the technological advances in pedestrian movement tracking.

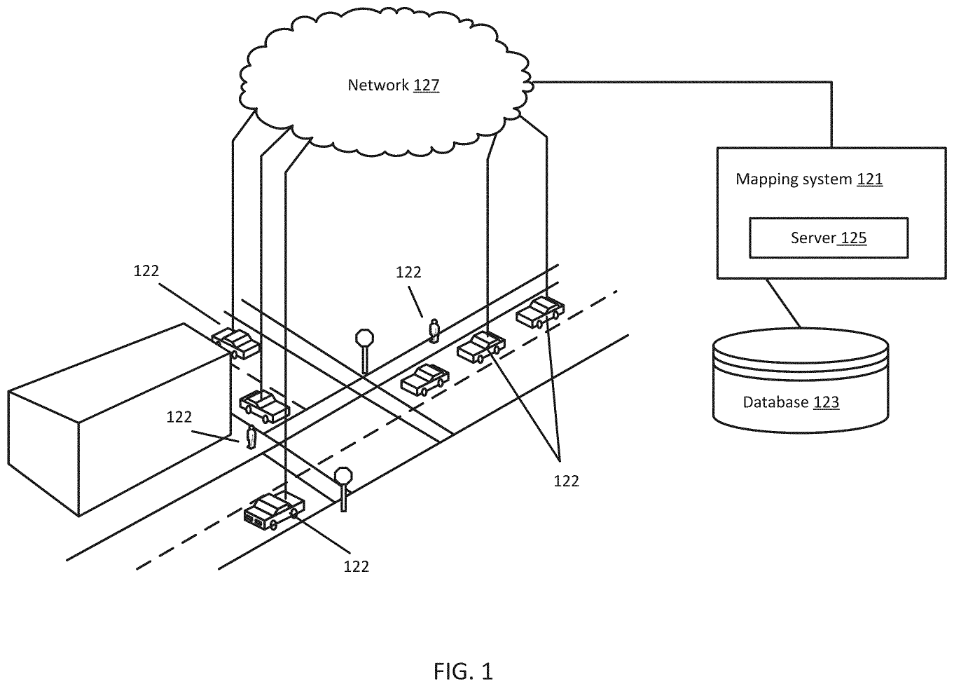

FIG. 1 illustrates an example system for tracking and reporting pedestrian movement patterns. The system includes one or more devices 122, a network 127, and a mapping system 121. The mapping system 121 may include a database 123 (also referred to as a geographic database 123 or map database) and a server 125. Additional, different, or fewer components may be included.

The one or more devices 122 may also include probe devices, probe sensors, IoT (internet of things) devices, or other devices 122 such as personal navigation devices 122 or connected vehicles. The devices 122 may be a mobile device or a tracking device that provides samples of data for the location of a person. The devices 122 may include mobile phones running specialized applications that collect location data as the devices 122 are carried by persons or things traveling a roadway system. The one or more devices 122 may include traditionally dumb or non-networked physical devices and everyday objects that have been embedded with one or more sensors or data collection applications and are configured to communicate over a network 127 such as the internet. The devices may be configured as data sources that are configured to acquire roadway data related to pedestrian movement. These devices 122 may be remotely monitored and controlled. The devices 122 may be part of an environment in which each device 122 communicates with other related devices in the environment to automate tasks. The devices may communicate sensor data to users, businesses, and, for example, the mapping system 121. At least some of the devices 122 are configured to acquire data about the movement of a pedestrian. Certain devices 122, for example those that are embedded in a vehicle, may acquire data about the roadway as the vehicle traverses the roadway. The server 125 is configured to separate or filter out the vehicular data from the pedestrian data.

Each mobile device 122 may include position circuitry such as one or more processors or circuits for generating probe data. The probe data may be generated by receiving GNSS signals and comparing the GNSS signals to a clock to determine the absolute or relative position of the mobile device 122. The probe data may be generated by receiving radio signals or wireless signals (e.g., cellular signals, the family of protocols known as WiFi or IEEE 802.11, the family of protocols known as Bluetooth, or another protocol) and comparing the signals to a pre-stored pattern of signals (e.g., radio map).

The probe data may include a geographic location such as a longitude value and a latitude value. In addition, the probe data may include a height or altitude. The probe data may be collected over time and include timestamps. In some examples, the probe data is collected at a predetermined time interval (e.g., every second, ever 100 milliseconds, or another interval). The probe data may also describe the speed, or velocity, of the mobile device 122. The speed may be determined from the changes of position over a time span calculated from the difference in respective timestamps. The time span may be the predetermined time interval, that is, sequential probe data may be used. The term probe data may also be used to describe the speed data.

In some examples, the probe data is collected in response to movement by the device 122 (for example the device 122 reports location information when the device 122 moves a threshold distance). The predetermined time interval for generating the probe data may be specified by an application or by the user. The interval for providing the probe data from the mobile device 122 to the server 125 may be may the same or different than the interval for collecting the probe data. The interval may be specified by an application or by the user.

The probe data is received by the server 125 or the mapping system 121 and stored in the geographic database 123. The probe data may be analyzed, sorted, adjusted, and filtered prior to storing. The geographic database 123 and a high-definition map are maintained and updated by the mapping system 121 using the probe data and other information. The mapping system 121 may include multiple servers, workstations, databases, and other machines connected together and maintained by a map developer. The mapping system 121 may be configured to acquire and process data relating to the roadway. For example, the mapping system 121 may receive and input data such as vehicle data, user data, weather data, road condition data, road works data, traffic feeds, etc. The data may be historical, real-time, or predictive.

The server 125 may be a host for a website or web service such as a mapping service and/or a navigation service. The mapping service may provide standard maps or HD maps generated from the geographic data of the database 123, and the navigation service may generate routing or other directions from the geographic data of the database 123. The mapping service may also provide information generated from attribute data included in the database 123. The server 125 may also provide historical, future, recent or current traffic conditions for the links, segments, paths, or routes using historical, recent, or real time collected data. The server 125 is configured to communicate with the devices 122 through the network 127. The server 125 is configured to receive a request from a device 122 for a route or maneuver instructions and generate one or more potential routes or instructions using data stored in the geographic database 123.

The server 125 is configured to filter/separate pedestrian probe data from other probe data. The server 125 may determine a transportation mode and/or state to associate with a device 122 and/or probe points generated during travel along a road segment. Different transportation modes include at least a pedestrian transport mode and a vehicle transport mode among other forms or types of travel. The transportation mode may also specify or be associated with a type of lane travelled on by a pedestrian or vehicle relative to a current set of probe points produced, i.e., a pedestrian lane or vehicle lane. Different states may also be assigned to a device 122 or probe data at a certain time. For example, a pedestrian state corresponds to walking, running or any form/mode of travel executed by a person without the support of mechanical, motorized, or other vehicular or transport means. A vehicle state corresponds to any form/mode of travel involving mechanical and/or motorized vehicular or other transport means (e.g., bicycle, car, hovercraft). A device 122 may switch between two states, for example, carried by a pedestrian walking that then boards a bus or other vehicle for the remainder of a trip.

The server 125 may model an aggregate of the probe data to transcend the limitations of extracting location, speed, or other such parameters alone or in limited combinations. Aggregation may include location, speed, direction, heading (direction) change rate, and other parameters as mode indicators to determine patterns characteristic of a particular mode, such as may be the case for a pedestrian or non-pedestrian (passenger vehicle, cyclist, train, etc.). The selection of parameters may be based on one or more probabilities that the attributes of the probe trace data reflect different modes. In an example, for a dataset of pedestrian data, a comparison may be made between the gathered pedestrian data and known pedestrian probe trace datasets. By this comparison, an analysis may be made as to quantify and qualify characteristics of pedestrian behavior within the obtained pedestrian probe trace datasets. The attributes be any known or derived characteristic of pedestrian transport including location, path characteristics, speed, start and stop behavior, and other like attributes. Likewise, a dataset of non-pedestrian data may be obtained and compared with non-pedestrian datasets including those of passenger vehicles, bicycles, public transportation, and other like non-pedestrian modes of transport. The like attributes may be characterized and catalogued to distinguish these modes from one another and further from the pedestrian mode data. Also, an unknown proportion of the obtained data may be ambiguous or of an uncertainty significant enough to warrant withholding a classification until more and/or better comparisons may be made with known classifiable datasets. Thus, each obtainable probe trace dataset—pedestrian, non-pedestrian, ambiguous—may be classified based on a categorization of the probe trace data using one or more characteristics or attributes including a speed of travel, location in the spatial domain, smartphone reporting activity, path characteristics, or a combination thereof. This may be done in one or more iterations to achieve a greater confidence and/or accuracy.

The server 125 may use a number of simple parameters and guidelines to categorize the probe trace data, for example as pedestrian or non-pedestrian mode, before using more intensive analytical techniques. For example, pedestrian probe data may be classified as such by determining if the probe trace data in question originated from one or more pedestrian zones; the probe trace proceeds in the wrong direction on a one-way street; and/or originates from a street that is closed to non-pedestrian traffic. Thus, using a simple analysis, a proportion of the data may be easily classified. Similarly, non-pedestrian data may be classified by other simple criteria. For example, non-pedestrian probe data may be classified as such by determining if the probe trace data in question includes probe traces traveling at non-pedestrian speed, originates from a fleet of multiple probe traces traveling in a way characteristic of non-probe data, or the probe trace data originates from a street with no pedestrian paths or is otherwise inaccessible to pedestrians.

The server 125 is configured to map match the pedestrian probe data to links and nodes stored in the geographic database 123. Different map matching algorithms may be used. A simple map matching process may match the closest spatial segment to a positional point. A more complex map matching algorithm may use additional information such as heading, speed, prior segments, etc. The server 125 is configured to identify sequences of pedestrian probe data in order to generate pedestrian paths including a starting point, an ending point, and potentially one or more links in-between. The server 125 is configured to aggregate the pedestrian probe data and pedestrian paths for a period of time.

The server 125 is configured to calculate a historical PDP and PFP for different epochs. The PDP may be calculated for different areas such as points of interests, nodes, segments, clusters, types of areas, quadkeys, etc. The main metrics in PDP is count over a geographic area (quadkey or zip code) or a linear or a POI. The metric in PFP is count and average flow speed (or travel-time) over a linear or an OD. The PDP may be generated using probe data analytics and algorithm in which probes are map-matched to areas and linear (with varying granularity) and aggregated using day-epoch or week-epochs over last 1 month or 3 months or 1 year. The PFP may be generated using probe data analytics and algorithms in which probes are map-matched to OD areas and linear (with varying granularity) and obtain average travel time or journey time (JT) in OD and aggregated using day-epoch or week-epochs over last 1 month or 3 months or 1 year.

The server 125 is configured to calculate real time PDP and PFP. The server 125 is configured to compare the historical PDP and PFP with the real-time PDP and PFP and calculate a surprise value that is indicative of an increase or decrease in the real-time PDP and PFP compared to the historical PDP and PFP. In an embodiment, the surprise value is obtained by finding the difference between current (real-time) metrics with the historical metrics. For example, in a 5 mins week-epoch, the server 125 calculates:

SPD_{count}(t)=PD_{count}^{r}(t)−PD_{count}^{h}(t)

SPF_{count}(t)=PF_{count}^{r}(t)−PF_{count}^{h}(t)

SPFⱼₜ(t)=PFⱼₜ^{r}(t)−PFⱼₜ^{h}(t)

where PFⱼₜ^{r}(t) is Pedestrian flow average journey time in real-time at an epoch time t and PD_{count}^{h}(t) is the historical Pedestrian Density (probe count) at an epoch time t.

The server 125 is configured to provide the surprise value and the PDP/PFP metrics for use by outside entities and applications. The server 125 may store the data in the geographic database 123 which may allow access or broadcast data to various entities for use in navigation related services.

To communicate with the devices 122, systems, or services, the server 125 is connected to the network 127. The server 125 may receive or transmit data through the network 127. The server 125 may also transmit paths, routes, or risk data through the network 127. The server 125 may also be connected to an OEM cloud that may be used to provide mapping services to vehicles via the OEM cloud or directly by the mapping system 121 through the network 127. The network 127 may include wired networks, wireless networks, or combinations thereof. The wireless network may be a cellular telephone network, LTE (Long-Term Evolution), 4G LTE, a wireless local area network, such as an 802.11, 802.16, 802.20, WiMAX (Worldwide Interoperability for Microwave Access) network, DSRC (otherwise known as WAVE, ITS-G5, or 802.11p and future generations thereof), a 5G wireless network, or wireless short-range network such as Zigbee, Bluetooth Low Energy, Z-Wave, RFID and NFC. Further, the network 127 may be a public network, such as the Internet, a private network, such as an intranet, or combinations thereof, and may utilize a variety of networking protocols now available or later developed including, but not limited to transmission control protocol/internet protocol (TCP/IP) based networking protocols.

The HD map and the geographic database 123 may be maintained by a content provider (e.g., a map developer). By way of example, the map developer may collect geographic data to generate and enhance the geographic database 123. The map developer may obtain data from sources, such as businesses, municipalities, or respective geographic authorities. In addition, the map developer may employ field personnel to travel throughout the geographic region to observe features and/or record information about the roadway. Remote sensing, such as aerial or satellite photography, may be used. The database 123 is connected to the server 125. The geographic database 123 and the data stored within the geographic database 123 may be licensed or delivered on-demand. Other navigational services or traffic server providers may access the traffic data stored in the geographic database 123. Data for an object or point of interest may be broadcast as a service.

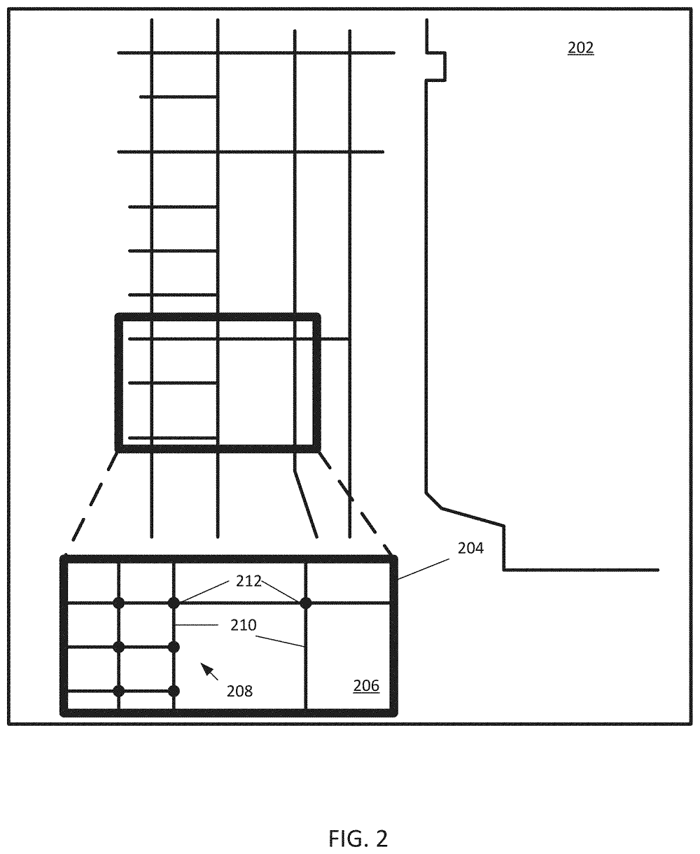

Information about the roadway, links, lanes, origins, destinations, and other information is stored in a geographic database 123. The geographic database 123 includes information about one or more geographic regions. FIG. 2 illustrates a map of a geographic region 202. The geographic region 202 may correspond to a metropolitan or rural area, a state, a country, or combinations thereof, or any other area. Located in the geographic region 202 are physical geographic features, such as roads, points of interest (including businesses, municipal facilities, etc.), lakes, rivers, railroads, municipalities, etc.

FIG. 2 further depicts an enlarged map 204 of a portion 206 of the geographic region 202. The enlarged map 204 illustrates part of a road network 208 in the geographic region 202. The road network 208 includes, among other things, roads and intersections located in the geographic region 202. As shown in the portion 206, each road in the geographic region 202 is composed of one or more road segments 210. A road segment 210 represents a portion of the road. Road segments 210 may also be referred to as links. Each road segment 210 is shown to have associated with it one or more nodes 212; one node represents the point at one end of the road segment and the other node represents the point at the other end of the road segment. The node 212 at either end of a road segment 210 may correspond to a location at which the road meets another road, i.e., an intersection, or where the road dead ends.

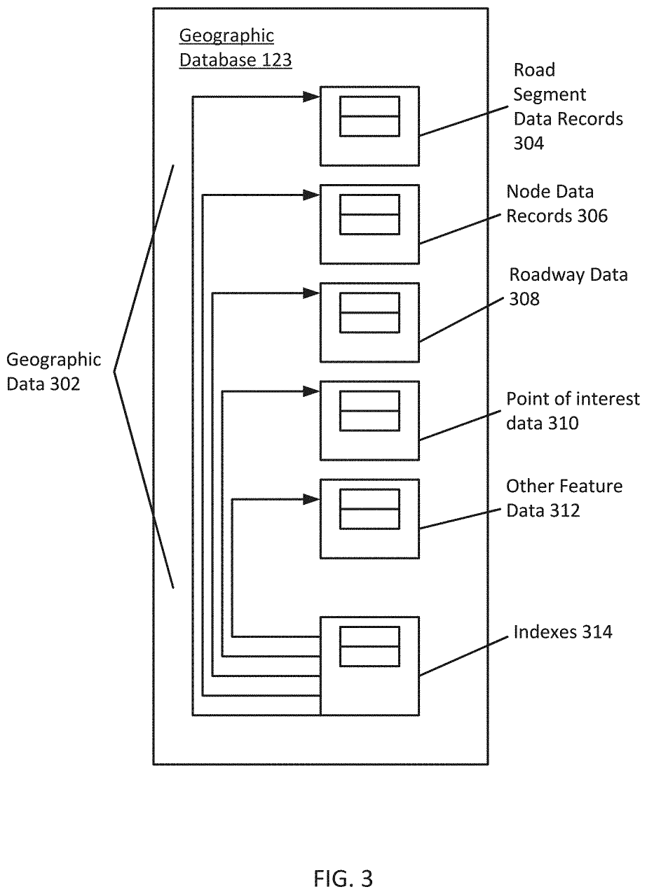

As depicted in FIG. 3, in one embodiment, the geographic database 123 contains geographic data 302 that represents some of the geographic features in the geographic region 202 depicted in FIG. 2. The data 302 contained in the geographic database 123 may include data that represent the road network 208. In FIG. 3, the geographic database 123 that represents the geographic region 202 may contain at least one road segment database record 304 (also referred to as “entity” or “entry”) for each road segment 210 in the geographic region 202. The geographic database 123 that represents the geographic region 202 may also include a node database record 306 (or “entity” or “entry”) for each node 212 in the geographic region 202. The terms “nodes” and “segments” represent only one terminology for describing these physical geographic features, and other terminology for describing these features is intended to be encompassed within the scope of these concepts.

The geographic database 123 may include feature data 308-312. The feature data 312 may represent types of geographic features. For example, the feature data may include roadway data 308 including signage data, lane data, traffic signal data, physical and painted features like dividers, lane divider markings, road edges, center of intersection, stop bars, overpasses, overhead bridges etc. The roadway data 308 may be further stored in sub-indices that account for different types of roads or features. The point of interest data 310 may include data or sub-indices or layers for different types points of interest. The point of interest data may include point of interest records comprising a type (e.g., the type of point of interest, such as restaurant, fuel station, hotel, city hall, police station, historical marker, ATM, golf course, truck stop, vehicle chain-up stations etc.), location of the point of interest, a phone number, hours of operation, etc. The feature data 312 may include other roadway features. The geographic database 123 also includes indexes 314. The indexes 314 may include various types of indexes that relate the different types of data to each other or that relate to other aspects of the data contained in the geographic database 123. For example, the indexes 314 may relate the nodes in the node data records 306 with the end points of a road segment in the road segment data records 304.

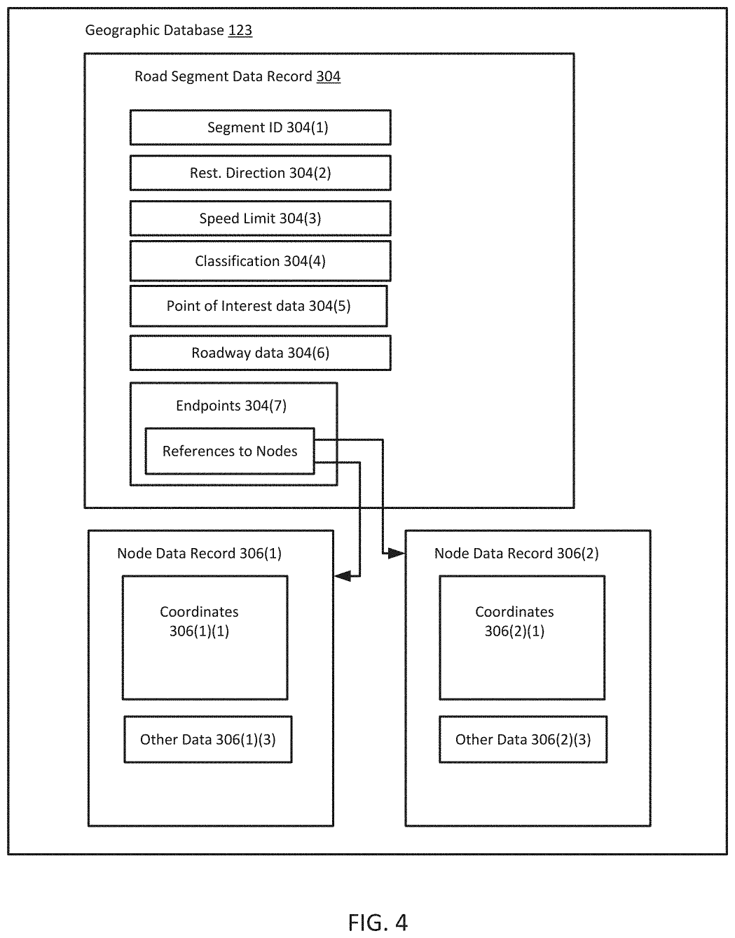

FIG. 4 shows some of the components of a road segment data record 304 contained in the geographic database 123 according to one embodiment. The road segment data record 304 may include a segment ID 304(1) by which the data record may be identified in the geographic database 123. Each road segment data record 304 may have associated with the data record, information such as “attributes”, “fields”, etc. that describes features of the represented road segment. The road segment data record 304 may include data 304(2) that indicate the restrictions, if any, on the direction of vehicular travel permitted on the represented road segment. The road segment data record 304 may include data 304(3) that indicate a speed limit or speed category (i.e., the maximum permitted vehicular speed of travel) on the represented road segment. The road segment data record 304 may also include data 304(4) indicating whether the represented road segment is part of a controlled access road (such as an expressway), a ramp to a controlled access road, a bridge, a tunnel, a toll road, a ferry, and so on. The road segment data record 304 may include data 304(5) related to points of interest. The road segment data record 304 may include data 304(6) that describes roadway data. The road segment data record 304 also includes data 304(7) providing the geographic coordinates (e.g., the latitude and longitude) of the end points of the represented road segment. In one embodiment, the data 304(7) are references to the node data records 306 that represent the nodes corresponding to the end points of the represented road segment. The road segment data record 304 may also include or be associated with other data 304(7) that refer to various other attributes of the represented road segment such as coordinate data for shape points, POIs, signage, other parts of the road segment, among others. The various attributes associated with a road segment may be included in a single road segment record or may be included in more than one type of record which cross-references to each other. For example, the road segment data record 304 may include data identifying what turn restrictions exist at each of the nodes which correspond to intersections at the ends of the road portion represented by the road segment, the name, or names by which the represented road segment is known, the street address ranges along the represented road segment, and so on.

FIG. 4 also shows some of the components of a node data record 306 which may be contained in the geographic database 123. Each of the node data records 306 may have associated information (such as “attributes”, “fields”, etc.) that allows identification of the road segment(s) that connect to it and/or a geographic position (e.g., latitude and longitude coordinates). For the embodiment shown in FIG. 4, the node data records 306(1) and 306(2) include the latitude and longitude coordinates 306(1)(1) and 306(2)(1) for their node. The node data records 306(1) and 306(2) may also include other data 306(1)(3) and 306(2)(3) that refer to various other attributes of the nodes. In an embodiment, the geographic database 123 stores the historical pedestrian data including the pedestrian probe data, the historical PDP, and historical PFP. The geographic database 123 may also include time stamps for different events that coincide with the pedestrian probe data. The event data (including for example, weather data) may also be used to set baseline values for PDP and PFP when the server 125 calculates surprise values. The pedestrian data may be stored as related to a segment, a node, a POI, an area, a quadkey, etc.

The data in in the geographic database 123 may also be organized using a graph that specifies relationships between entities. A Location Graph is a graph that includes relationships between location objects in a variety of ways. Objects and their relationships may be described using a set of labels. Objects may be referred to as “nodes” of the Location Graph, where the nodes and relationships among nodes may have data attributes. The organization of the Location Graph may be defined by a data scheme that defines the structure of the data. The organization of the nodes and relationships may be stored in an Ontology which defines a set of concepts where the focus is on the meaning and shared understanding. These descriptions permit mapping of concepts from one domain to another. The Ontology is modeled in a formal knowledge representation language which supports inferencing and is readily available from both open-source and proprietary tools.

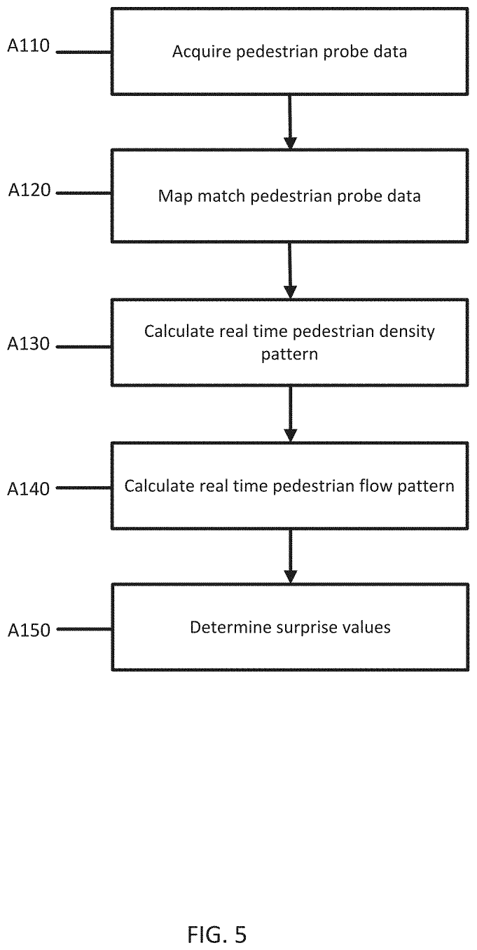

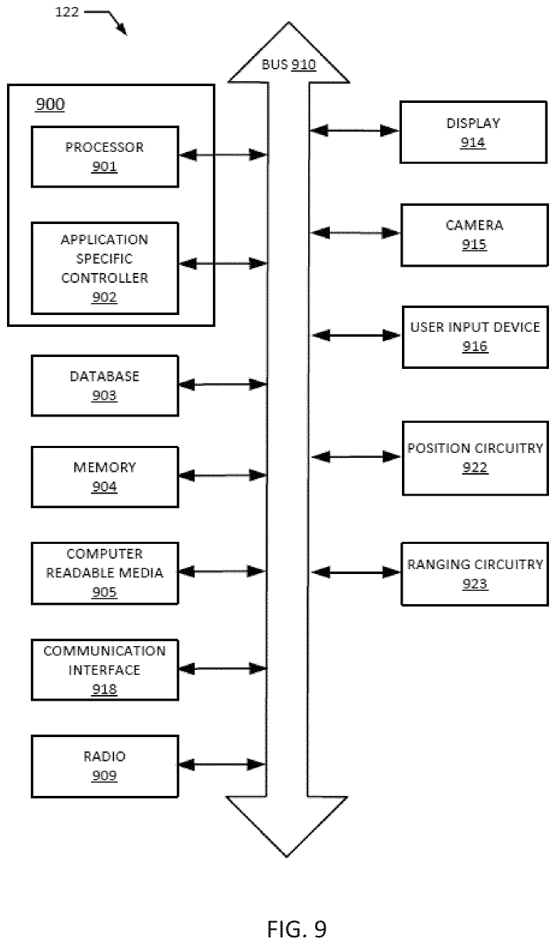

FIG. 5 depicts an example workflow for tracking pedestrian mobility. Pedestrian probe data (for example GPS data) is obtained and processed in various forms (for example probe points, probe trajectories, probe paths, origin-destination, OD trajectories, micro-ODs). A pedestrian density pattern (PDP) metric based on pedestrian count is then generated by map matching probe data to areas/roads/lanes and aggregating the probe data over a period of time (for example using day/week epochs). A pedestrian flow pattern metric based on pedestrian count and average flow speed (or travel time) is generated by map matching probes to OD areas and roads/lanes and then obtaining average travel time aggregated over a period of time (for example using day/week epochs). Then, a surprise pedestrian density and flow value are obtained by calculating a difference between real time metrics and historical metrics. As presented in the following sections, the acts may be performed using any combination of the components indicated in FIG. 1 or 9. The following acts may be performed by the server 125, the device 122, the mapping system 121, or a combination thereof. As an example, a copy of the geographic database 123 may be updated on the device 122 from the mapping system 121. The server 125 of the mapping system 121 may collect data from multiple devices 122 and provide this data to each of the devices 122 so that the devices are able to provide accurate instructions and services. Additional, different, or fewer acts may be provided. The acts are performed in the order shown or other orders. The acts may also be repeated. Certain acts may be skipped.

At act A110, the server 125 acquires pedestrian probe data from a plurality of probe apparatuses traversing a roadway network. The probe data may be stored in a geographic database 123. Each of the probe data may be received from a probe apparatus of a plurality of probe apparatuses, each probe apparatus traveling between a respective origin and destination pair, each probe apparatus comprising one or more sensors, wherein each probe data comprises location information associated with the respective probe apparatus. The probe data (e.g., collected by mobile device 122) is representative of the location of a pedestrian at a respective point in time and may be collected while a pedestrian is traveling along a route. While probe data is described herein as being pedestrian probe data, example embodiments may be implemented with alternative probe data such as vehicular probe data, marine vehicle probe data, or non-motorized vehicle probe data (e.g., from bicycles, skateboards, horseback, etc.). According to an embodiment described below with the probe data being from pedestrians traveling along roadways, the probe data may include, without limitation, location data, (e.g. a latitudinal, longitudinal position, and/or height, GPS coordinates, proximity readings associated with a radio frequency identification (RFID) tag, or the like), a lane identification, a rate of travel, (e.g. speed), direction of travel, (e.g. heading, cardinal direction, or the like), device identifier, (e.g. user identifier, or the like), a time stamp associated with the data collection, or the like. The mobile device 122, may be any device capable of collecting the aforementioned probe data. Some examples of the mobile device 122 may include specialized mapping equipment, navigational systems, mobile devices, such as phones or personal data assistants, or the like.

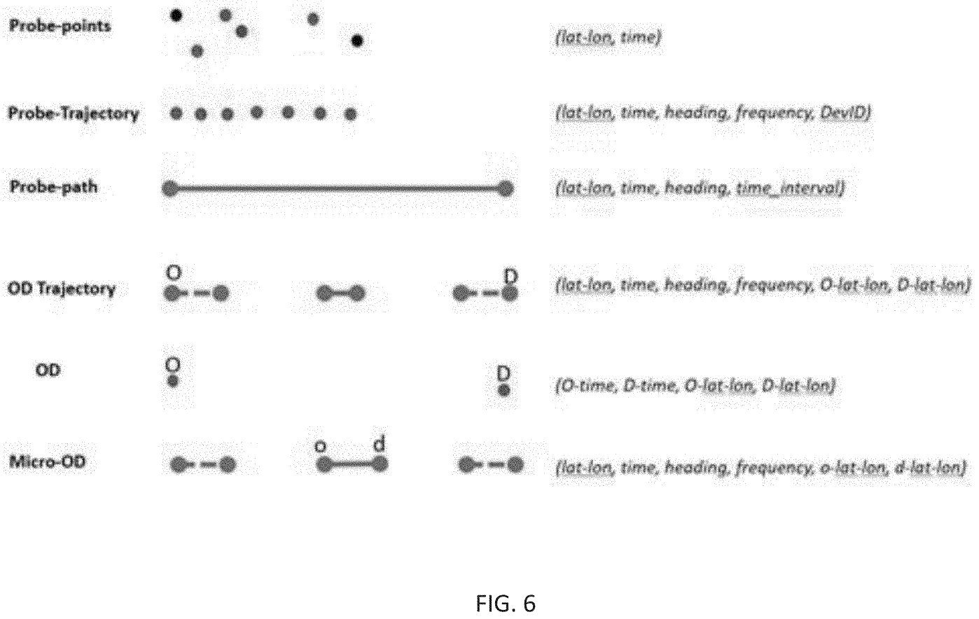

FIG. 6 depicts an example of different probe types including probe points, probe trajectories, probe paths, origin-destination, OD trajectories, and micro-ODs. Probe points include only a latitude value, a longitude value, and a time. The latitude (lat) and longitude (long) values may be derived from positional circuitry such as a GPS device. Probe trajectories include the lat/long values, time, heading, frequency, and ID. The ID ties the probe data points together while the heading describes the direction and the frequency describes how often the probes data points are collected. The probe-path includes lat-long, time, heading, and a time interval that describes the total time. OD trajectory includes the lat long, time, heading, frequency, and an OD lat-long describing the origin and a destination. OD includes a probe point for each of the origin and destination and respective times. Micro-OD includes lat-long, time, heading, frequency, and one or more micro or intermediate OD segments described by OD lat-long.

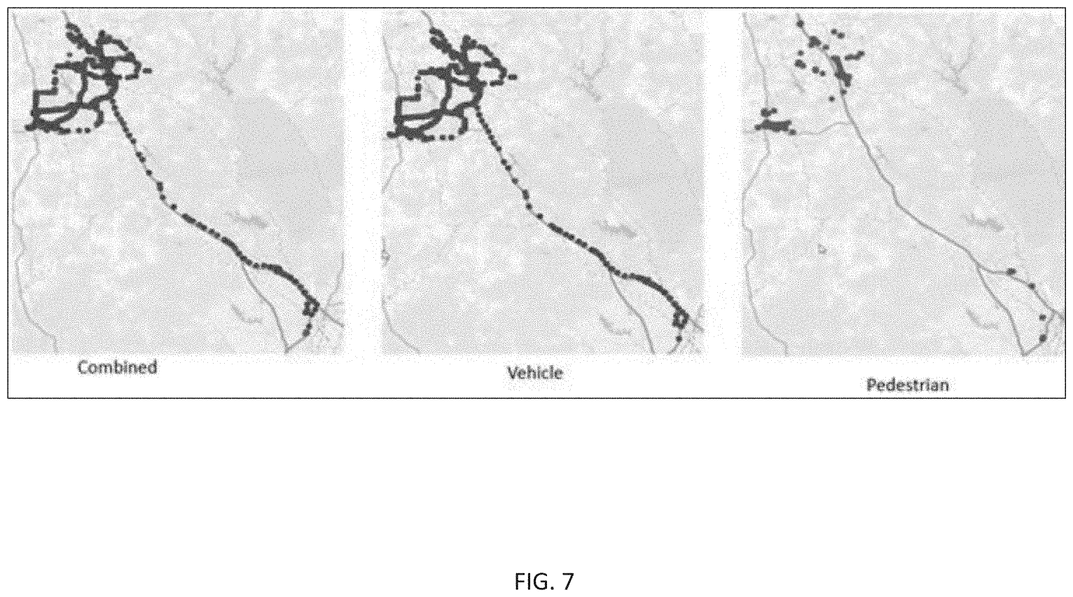

In an embodiment, the server 125 acquires probe data from the plurality of probe apparatuses for different modes of travel, filters the acquired probe data using a transportation mode detector, and partitions the filtered acquired probe data for use in calculating density and flow. In an embodiment, the transportation mode detector determines a speed of a probe point. The transportation mode detector also determines a spatial distance of the probe point from a center line vector of a road segment. The transportation mode detector also determines an allowed transport mode for the road segment. The transportation mode detector further identifies the transport mode of the probe point based on the speed, the location of the probe point with respect to the center line, and the allowed transport mode. The filtered acquired probe data may be portioned by separating data for the PDP and the PFP calculations. For example, sequenced probe data or OD probe data may be used for PFP. FIG. 7 depicts combined probe data, vehicle probe data, and pedestrian probe data after the data is filtered by the server 125. As depicted the pedestrian data is generally confined to the city centers as there is not much pedestrian mobility in between urban areas.

At act A120, the server 125 map matches each of the pedestrian probe data to respective links. In certain embodiments, the map matching may be performed by the device 122 wherein the link identifier or information may be included with the probe data. Alternatively, the lane which the device 122 was traversing may be identified after the fact by the server 125 or mapping system 121 from information included with the probe device. The map matcher may identify a route from an origin to a destination for each of the respective pedestrians. A map matcher may be run on each trajectory or pedestrian path traveled in order to obtain the link each pedestrian traveled in along their route.

Different map matching techniques may be used. In an embodiment, a GPS value may be used to identify the road segment using a map matching algorithm to match the GPS coordinates to a stored map and road segment. Map mapping techniques may be used to identify the link, for example, from the GPS data or additional sensor data included with the probe data. The probe data may be collected at a high enough spatial resolution to distinguish between different portions of the roadway, for example, a sidewalk and a lane of the roadway. As another example, map matching may provide a good estimate of what link a pedestrian is on given a sequence of GPS probes coming from the pedestrian. Sensor data such as lateral acceleration sensors may be used to identify a link.

In another example, the device 122 performs triangulation to determine the link of travel of the device 122. Triangulation may involve comparison of the angle, signal strength, or other characteristics of wireless radio signals received from one or more other devices. The positioning may be based on a received signal strength indicator (RSSI) measured at the mobile device 122. The RSSI may decrease proportionally to the square of the distance from the source of the signal. The positioning technique may analyze cellular signals received from multiple towers or cells. Position may be calculated from triangulation of the cellular signals. Several positioning techniques may be specialized for indoor applications such as pseudolites (GPS-like short range beacons), ultra-sound positioning, Bluetooth Low Energy (BTLE) signals (e.g., High-Accuracy Indoor Positioning, HAIP) and WiFi-Fingerprinting. The result of the map matching is one or more links for each of the pedestrians that provided probe data, each of the probe data containing at least a time stamp indicating the time the probe data was acquired.

At act A130, the server 125 calculates a real time pedestrian density pattern (PDP) metric based on the map matched pedestrian probe data for a current time period. The probe data may be separated by area, link, node, POI, quadkey, zip code, etc. A historical PDP is also generated using probe data analytics and algorithms in which the map matched probe data is aggregated using day-epoch or week-epochs over for example, a week, a month, 3 months, 6 months, 1 year, etc. For the historical PDP, the probe data may be filtered to remove outlier data and/or smoothed to provide a more accurate baseline pedestrian density pattern. As an example, certain events such as weather, holidays, concerts, etc. may drastically affect the pedestrian density for an area. Probe data acquired during these events may be taken into account when creating the PDP or may be filtered and used to model PDP for when these events are expected to occur. One example may be a recurring sporting event. Data acquired for such an event may not be used to calculate the baseline/historical PDP for a typical time period. This data, however, may be segregated and used to create a baseline/historical PDP for time periods in the future when the sporting event is scheduled to occur.

Historical PDP may be calculated at any time in the past. The historical PDP may be constantly updated as new probe data is acquired and stored in the geographic database 123. Real time PDP may be calculated in real time by aggregating and calculating a PDP value for the prior 5 min, 15 min, an hour, etc. Real time PDP may be calculated for the same epoch as provided by the historical PDP or may be calculated for different periods. Real-time PDP may be validated as discussed below by other mechanisms.

At act A140, the server 125 calculates a real time pedestrian flow pattern (PFP) metric based on pedestrian count and average flow speed derived by matching sequences of pedestrian probe data for respective links to origination and destination areas and obtaining average travel time aggregated over the current time period. In addition to OD areas, the PFP may be calculated between links, nodes, POIs, quadkeys, zip codes, etc. A historical PFP is generated using probe data analytics and algorithms where map matched probes and average travel time or journey time (JT) is aggregated using day-epoch or week-epochs over for example, 1 week, 1 month, 3 months, 6 months, 1 year, etc. Similar to the calculation of the PDP, the probe data for the historical PFP may be filtered to remove outlier data and/or smoothed to provide a more accurate baseline pedestrian traffic flow pattern.

Historical PFP may be calculated at any time in the past. The historical PFP may be constantly updated as new probe data is acquired and stored in the geographic database 123. Real time PFP may be calculated in real time by aggregating and calculating a PFP value for the prior 5 min, 15 min, an hour, etc. Real time PFP may be calculated for the same epoch as provided by the historical PFP or may be calculated for different periods. Real-time PFP may be validated as discussed below by other mechanisms.

At act A150, the server 125 determines a surprise pedestrian density value and a surprise pedestrian flow value by calculating a difference between historical metrics stored in a geographic database 123 and the real time metrics. In an embodiment, the surprise pedestrian density value and the surprise pedestrian flow value are calculated by finding the difference between current (real-time) metrics with the historical metrics, for example by calculating the following:

SPD_{count}(t)=PD_{count}^{r}(t)−PD_{count}^{h}(t)

SPF_{count}(t)=PF_{count}^{r}(t)−PF_{count}^{h}(t)

SPFⱼₜ(t)=PFⱼₜ^{r}(t)−PFⱼₜ^{h}(t)

where PFⱼₜ^{r}(t) is Pedestrian flow average journey time in real-time at an epoch time t and PD_{count}^{h}(t) is historical Pedestrian Density (probe count) at an epoch time t.

In an embodiment, values for the historical PDP may be stored in the geographic database 123 in the following format.

TABLE 1

| Quadkey/ | Aggregation | Time (Week- | |
|---|---|---|---|
| Segment-ID | Period | epoch) | SPD |
| 60606 | 3 months | e.g. 15 mins | Count |
| | | week epoch | <integer> |

A positive surprise pedestrian density (SPD) means there is an increase in pedestrian density whereas a negative SPD value implies there is a decrease, the magnitude of change (increase or decrease) is |SPD| and may be compared over time to obtain the percentile of the change.

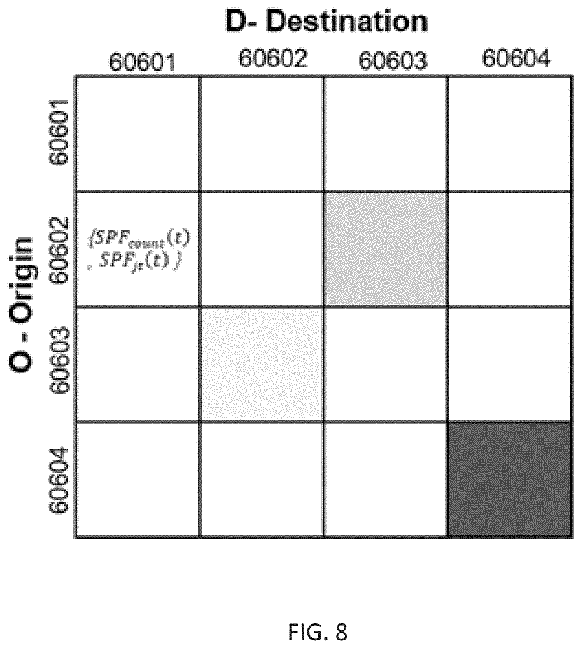

The SPDF data may be published via an API feed to various customers or displayed on a map visualization or an OD matrix data structure for display or publishing (SPF only). FIG. 8 depicts an example OD matrix data structure. The OD-Matrix data structure captures surprises in pedestrian movement or flow by showing the spatial location that is being compared. In FIG. 8, the ODs are locations of any probe observation, for example, the OD does not have to be the exact start and end of the probe trajectory journey, but rather may describe an intermediate journey. In an embodiment, the visualization aspect that be done by using grey coloring such that the darker or whiter it is, the more significant the surprise is in which white may be the positive surprise extreme and black being a negative surprise. Any color codes may be used, the absolute value |SPF| may also be used.

In an embodiment, the SDP may be used to automatically detect locations of events (where there is a sudden surge in pedestrian presence) around an event venue or POI. In an embodiment, the SDP may be used to measure how well different regions of the city is following a “stay at home” order. In an embodiment, the SDF may be used to understand where people migrating to or from (valuable data for epidemiology research). In an embodiment, the surprise value and historical/real-time metrics may be applied by retail stores and businesses to discover new hot spots and react immediately to changing conditions. In an embodiment, the surprise value and historical/real-time metrics may be used for location-based advertisements. In an embodiment, predictions based on previous surprise values and historical/real-time metrics data obtained during certain events may be used to predict how pedestrian mobility for future events will be like and this may be valuable data for retail and hospitality organizations.

In an embodiment, the real time metrics may be validated by using other mechanisms than probe data. Ground truth data may be acquired using various sensors to identify actual pedestrian mobility. The ground truth data may be used to adjust or otherwise correct the historical patterns. The ground truth data may also be used to accurately identify the density by equating the ground truth data and the probe data to understand the probe penetration rate.

FIG. 9 illustrates an example mobile device 122 for the system of FIG. 1 carried by or otherwise accompanying a pedestrian that is configured to acquire probe data. The mobile device 122 may include a bus 910 that facilitates communication between a controller 900 that may be implemented by a processor 901 and/or an application specific controller 902, which may be referred to individually or collectively as controller 900, and one or more other components including a database 903, a memory 904, a computer readable medium 905, a communication interface 918, a radio 909, a display 914, a camera 915, a user input device 916, position circuitry 922, and ranging circuitry 923. The contents of the database 903 are described with respect to the geographic database 123. The device-side database 903 may be a user database that receives data in portions from the database 903 of the mobile device 122. The communication interface 918 connected to the internet and/or other networks (e.g., network 127 shown in FIG. 1). Additional, different, or fewer components may be included.

The device 122 is configured to acquire probe data for use in tracking pedestrian density and flow. The device 122 is configured to determine its position using the positioning circuitry 922, generate a report using the controller 900, and transmit the probe report to a mapping system 121 using the communication interface 918. The device 122 may also be configured to acquire and view data from a geographic database 123.

The controller 900 may include a routing module including an application specific module or processor that calculates routing between an origin and destination. The routing module is an example means for generating a route. The display 914 is an example means for displaying the routing command. The mobile device 122 may generate a routing instruction based on the anonymized data.

The routing instructions may be provided by the display 914. The mobile device 122 may be configured to execute routing algorithms to determine an optimum route to travel along a road network from an origin location to a destination location in a geographic region. Using input(s) including map matching values from the mapping system 121, a mobile device 122 examines potential routes between the origin location and the destination location to determine the optimum route. The mobile device 122, which may be referred to as a navigation device, may then provide the end user with information about the optimum route in the form of guidance that identifies the maneuvers required to be taken by the end user to travel from the origin to the destination location. Some mobile devices 122 show detailed maps on displays outlining the route, the types of maneuvers to be taken at various locations along the route, locations of certain types of features, and so on. Possible routes may be calculated based on a Dijkstra method, an A-star algorithm or search, and/or other route exploration or calculation algorithms that may be modified to take into consideration assigned cost values of the underlying road segments. The mobile device 122 may be a personal navigation device (“PND”), a portable navigation device, a mobile phone, a personal digital assistant (“PDA”), a watch, a tablet computer, a notebook computer, and/or any other known or later developed mobile device or personal computer. The mobile device 122 may also be an automobile head unit, infotainment system, and/or any other known or later developed automotive navigation system. Non-limiting embodiments of navigation devices may also include relational database service devices, mobile phone devices, car navigation devices, and navigation devices used for air or water travel.

The radio 909 may be configured to radio frequency communication (e.g., generate, transit, and receive radio signals) for any of the wireless networks described herein including cellular networks, the family of protocols known as WIFI or IEEE 802.11, the family of protocols known as Bluetooth, or another protocol.

The memory 904 may be a volatile memory or a non-volatile memory. The memory 904 may include one or more of a read-only memory (ROM), random access memory (RAM), a flash memory, an electronic erasable program read only memory (EEPROM), or other type of memory. The memory 904 may be removable from the mobile device 122, such as a secure digital (SD) memory card.

The communication interface 918 may include any operable connection. An operable connection may be one in which signals, physical communications, and/or logical communications may be sent and/or received. An operable connection may include a physical interface, an electrical interface, and/or a data interface. The communication interface 818 and/or communication interface 918 provides for wireless and/or wired communications in any now known or later developed format.

The input device 916 may be one or more buttons, keypad, keyboard, mouse, stylus pen, trackball, rocker switch, touch pad, voice recognition circuit, or other device or component for inputting data to the mobile device 122. The input device 916 and display 914 be combined as a touch screen, which may be capacitive or resistive. The display 914 may be a liquid crystal display (LCD) panel, light emitting diode (LED) screen, thin film transistor screen, or another type of display. The output interface of the display 914 may also include audio capabilities, or speakers. In an embodiment, the input device 916 may involve a device having velocity detecting abilities.

The positioning circuitry 922 may include suitable sensing devices that measure the traveling distance, speed, direction, and so on, of the mobile device 122. The positioning system may also include a receiver and correlation chip to obtain a GPS signal. Alternatively, or additionally, the one or more detectors or sensors may include an accelerometer and/or a magnetic sensor built or embedded into or within the interior of the mobile device 122. The accelerometer is operable to detect, recognize, or measure the rate of change of translational and/or rotational movement of the mobile device 122. The magnetic sensor, or a compass, is configured to generate data indicative of a heading of the mobile device 122. Data from the accelerometer and the magnetic sensor may indicate orientation of the mobile device 122. The mobile device 122 receives location data from the positioning system. The location data indicates the location of the mobile device 122.

The positioning circuitry 922 may include a Global Positioning System (GPS), Global Navigation Satellite System (GLONASS), or a cellular or similar position sensor for providing location data. The positioning system may utilize GPS-type technology, a dead reckoning-type system, cellular location, or combinations of these or other systems. The positioning circuitry 922 may include suitable sensing devices that measure the traveling distance, speed, direction, and so on, of the mobile device 122. The positioning system may also include a receiver and correlation chip to obtain a GPS signal. The mobile device 122 receives location data from the positioning system. The location data indicates the location of the mobile device 122. The position circuitry 922 may also include gyroscopes, accelerometers, magnetometers, or any other device for tracking or determining movement of a mobile device. The gyroscope is operable to detect, recognize, or measure the current orientation, or changes in orientation, of a mobile device. Gyroscope orientation change detection may operate as a measure of yaw, pitch, or roll of the mobile device.

The ranging circuitry 923 may include a LiDAR system, a RADAR system, a structured light camera system, SONAR, or any device configured to detect the range or distance to objects from the mobile device 122. The ranging circuitry may also include cameras at different angles and may be capable of maintaining a 360° view of its external environment. The device 122 may utilize 3D cameras for displaying highly detailed and realistic images. These image sensors automatically detect objects, classify them, and determine the distances between them and the device 122. For example, the cameras may easily identify other cars, pedestrians, cyclists, traffic signs and signals, road markings, bridges, and guardrails.

The term “computer-readable medium” includes a single medium or multiple medium, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations may include distributed processing, component/object distributed processing, and parallel processing. Alternatively, virtual computer system processing may be constructed to implement one or more of the methods or functionalities as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in the specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

As used in the application, the term ‘circuitry’ or ‘circuit’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor receives instructions and data from a read only memory or a random-access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a GPS receiver, to name just a few. Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The memory may be a non-transitory medium such as a ROM, RAM, flash memory, etc. The processor and the memory may be supplemented by, or incorporated in, special purpose logic circuitry.

To provide for interaction with a user, embodiments of the subject matter described in this specification may be implemented on a device having a display, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments of the subject matter described in this specification may be implemented in a computing system that includes a back end component, e.g., as a data server, or that includes a middleware component, e.g., an application server, or that includes a front end component, e.g., a client computer having a graphical user interface or a Web browser through which a user may interact with an implementation of the subject matter described in this specification, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

1. A method for tracking pedestrian mobility, the method comprising:
acquiring pedestrian probe data from a plurality of probe apparatuses traversing a roadway network;
map matching each of the pedestrian probe data to respective links;
calculating a real time pedestrian density pattern metric based on the map matched pedestrian probe data for a current time period;
calculating a real time pedestrian flow pattern metric based on pedestrian count and average flow speed derived by matching sequences of pedestrian probe data for respective links to origination and destination areas and obtaining average travel time aggregated over the current time period; and
determining a surprise pedestrian density value and a surprise pedestrian flow value by calculating a difference between a historical pedestrian flow pattern metric and a historical pedestrian density pattern metric stored in a geographic database and the real time metrics.

2. The method of claim 1, wherein each probe apparatus of the plurality of probe apparatuses is traveling between a respective origin and destination pair, each probe apparatus comprising one or more sensors and being carried or accompanying a respective pedestrian, wherein each probe data comprises at least location information associated with a respective probe apparatus.

3. The method of claim 1, wherein acquiring comprises:
acquiring probe data from the plurality of probe apparatuses for different modes of travel;
filtering the acquired probe data using a transportation mode detector; and
partitioning the filtered acquired probe data for use in calculating density and flow.

4. The method of claim 1, wherein the real time pedestrian density pattern metric is calculated for different quadkey areas.

5. The method of claim 1, wherein the historical pedestrian density pattern metric is calculated by aggregating previously acquired probe data using day-epochs over a period of time.

6. The method of claim 1, wherein map matching each of the pedestrian probe data comprises map matching GPS data in the pedestrian probe data to a pedestrian link stored in the geographic database.

7. The method of claim 1, wherein the historical pedestrian flow pattern metric is calculated by aggregating average journey time derived from previously acquired probe data using day-epochs over a period of time.

8. The method of claim 1, further comprising:
identifying, automatically, locations of events where there is an increase in the real time pedestrian density pattern metric.

9. The method of claim 1, further comprising:
measuring, automatically, how well different regions of a city are following a stay-at-home order.

10. The method of claim 1, further comprising:
publishing the surprise pedestrian values via an API feed for use by one or more applications.

11. The method of claim 10, further comprising:
generating an origin destination matrix data structure for a surprise pedestrian flow patten value; wherein the origin destination matrix data structure is published for use by one or more navigation services.

12. A system for tracking pedestrian mobility, the system comprising:
a geographic database configured to store pedestrian probe data acquired from a plurality of probe apparatuses traversing a roadway network;
a mapping server configured to map match each of the pedestrian probe data to respective links, calculate a real time pedestrian density pattern metric based on the map matched pedestrian probe data for a current time period, and calculate a real time pedestrian flow pattern metric based on pedestrian count and average flow speed derived by matching sequences of pedestrian probe data for respective links to origination and destination areas and obtaining average travel time aggregated over the current time period;
the mapping server further configured to determine a surprise pedestrian density value and a surprise pedestrian flow value by calculating a difference between a historical pedestrian flow pattern metric and a historical pedestrian density pattern metric stored in a geographic database and the real time metrics.

13. The system of claim 12, wherein each probe apparatus of the plurality of probe apparatuses is traveling between a respective origin and destination pair, each probe apparatus comprising one or more sensors and being carried or accompanying a respective pedestrian, wherein each probe data comprises at least location information associated with a respective probe apparatus.

14. The system of claim 12, wherein the mapping server is configured to filter pedestrian probe data from other probe data stored in the geographic database.

15. The system of claim 12, wherein the real time pedestrian density pattern metric is calculated for different quadkey areas.

16. The system of claim 12, wherein the historical pedestrian density pattern metric is calculated by aggregating previously acquired probe data using day-epochs over a period of time.

17. The system of claim 12, wherein map matching each of the pedestrian probe data comprises map matching GPS data in the pedestrian probe data to a pedestrian link stored in the geographic database.

18. The system of claim 12, wherein the historical pedestrian flow pattern metric is calculated by aggregating average journey time derived from previously acquired probe data using day-epochs over a period of time.

19. The system of claim 12, wherein the mapping server is further configured to identify locations of events based on an increase over time in the real time pedestrian density pattern metric.

20. An apparatus comprising:
at least one processor; and
at least one memory including computer program code for one or more programs; the at least one memory configured to store the computer program code configured to, with the at least one processor, cause the at least one processor to:
acquire pedestrian probe data from a plurality of probe apparatuses traversing a roadway network;
map match each of the pedestrian probe data to respective links;
calculate a real time pedestrian density pattern metric based on the map matched pedestrian probe data for a current time period;
calculate a real time pedestrian flow pattern metric based on pedestrian count and average flow speed derived by matching sequences of pedestrian probe data for respective links to origination and destination areas and obtaining average travel time aggregated over the current time period; and
determine a surprise pedestrian density value and a surprise pedestrian flow value by calculating a difference between a historical pedestrian flow pattern metric and a historical pedestrian density pattern metric stored in a geographic database and the real time metrics.
